(19) United States
(12) Patent Application Publication
(10) Pub. No.: US 2025/0039629 A1
(43) Pub. Date: Jan. 30, 2025

(54) THREE-DIMENSIONAL AUDIO PROCESSING METHOD, THREE-DIMENSIONAL AUDIO PROCESSING DEVICE, AND RECORDING MEDIUM

(71) Applicant: Panasonic Intellectual Property Corporation of America, Torrance, CA (US)

(72) Inventors: Mariko YAMADA, Hyogo (JP); Tomokazu ISHIKAWA, Osaka (JP); Seigo ENOMOTO, Kyoto (JP); Hikaru USAMI, Osaka (JP); Kota NAKAHASHI, Osaka (JP); Hiroyuki EHARA, Kanagawa (JP); Ko MIZUNO, Osaka (JP)

(21) Appl. No.: 18/909,246

(22) Filed: Oct. 8, 2024

Related U.S. Application Data
(63) Continuation of application No. PCT/JP2023/009601, filed on Mar. 13, 2023.
(60) Provisional application No. 63/330,839, filed on Apr. 14, 2022.

(30) Foreign Application Priority Data
Feb. 27, 2023 (JP) 2023-028857

(51) Int. Cl. H04S 7/00

(52) U.S. Cl. CPC H04S 7/304; H04S 2400/11

(57) ABSTRACT

A three-dimensional audio processing method for use in reproducing three-dimensional audio using an augmented reality (AR) device includes: obtaining change information indicating change occurring in a space in which the AR device is located when content that includes a sound is being output in the AR device; selecting, based on the change information, one or more audio processes among a plurality of audio processes for rendering sound information indicating the sound; executing only the one or more audio processes selected among the plurality of audio processes; and rendering the sound information based on a first processing result of each of the one or more audio processes executed.

### CROSS REFERENCE TO RELATED APPLICATIONS

This is a continuation application of PCT International Application No. PCT/JP2023/009601 filed on Mar. 13, 2023, designating the United States of America, which is based on and claims priority of U.S. Provisional Patent Application No. 63/330,839 filed on Apr. 14, 2022 and Japanese Patent Application No. 2023-028857 filed on Feb. 27, 2023. The entire disclosures of the above-identified applications, including the specifications, drawings and claims are incorporated herein by reference in their entirety.

### FIELD

The present disclosure relates to a three-dimensional audio processing method, a three-dimensional audio processing device, and a recording medium.

### BACKGROUND

Patent Literature (PTL) 1 discloses a technique for obtaining acoustic features (acoustic characteristics) of an indoor space using devices, such as a microphone array for measurement and a loudspeaker array for measurement.

### CITATION LIST

### Patent Literature

PTL 1: Japanese Unexamined Patent Application Publication No. 2012-242597

### SUMMARY

### Technical Problem

There are cases where the acoustic features of the actual space, which are obtained in the technique in the above-mentioned PTL 1, are used when rendering sound information that indicates a sound that is output from an augmented reality (AR) device. In such cases, changes may conceivably occur in the above-mentioned space, such as by a person exiting or entering the space, an object in the space being moved, or an object being added or removed during use of the AR device. In other words, changes may conceivably occur in the acoustic features of the space during use of the AR device.

It is desirable for such changes occurring in the space during use to be readily reflected in the sound that is output from the AR device. However, PTL 1 does not disclose a technique for readily reflecting changes occurring in the space during use.

In view of this, the present disclosure provides a three-dimensional audio processing method, a three-dimensional audio processing device, and a recording medium that can readily reflect, in the rendering of sound information, a change in an acoustic feature occurring due to a change made to a space.

### Solution to Problem

A three-dimensional audio processing method according to one aspect of the present disclosure is a three-dimensional audio processing method in reproducing for use three-dimensional audio using an augmented reality (AR) device, and the three-dimensional audio processing method includes: obtaining change information indicating change occurring in a space in which the AR device is located when content that includes a sound is being output in the AR device; selecting, based on the change information, one or more audio processes among a plurality of audio processes for rendering sound information indicating the sound; executing only the one or more audio processes selected among the plurality of audio processes; and rendering the sound information based on a first processing result of each of the one or more audio processes executed.

A three-dimensional audio processing device according to one aspect of the present disclosure is a three-dimensional audio processing device for use in reproducing three-dimensional audio using an augmented reality (AR) device, and the three-dimensional audio processing device includes: an obtainer that obtains change information indicating change occurring in a space in which the AR device is located when content that includes a sound is being output in the AR device; a selector that selects, based on the change information, one or more audio processes among a plurality of audio processes for rendering sound information indicating the sound; an audio processor that executes only the one or more audio processes selected among the plurality of audio processes; and a renderer that renders the sound information based on a first processing result of each of the one or more audio processes executed.

A recording medium according to one aspect of the present disclosure is a non-transitory computer-readable recording medium having recorded thereon a program for causing a computer to execute the above-mentioned three-dimensional audio processing method.

### Advantageous Effects

According to one aspect of the present disclosure, a three-dimensional audio processing method and the like can be achieved that are capable of readily reflecting, in rendering performed on sound information, a change in an acoustic feature caused by a change occurring in a space.

### BRIEF DESCRIPTION OF DRAWINGS

FIG. 1 is a block diagram of a functional configuration of a three-dimensional audio processing device according to an embodiment.

FIG. 2 is a flowchart illustrating operation of the three-dimensional audio processing device according to the embodiment before use of an AR device.

FIG. 3 is a flowchart illustrating operation of the three-dimensional audio processing device according to the embodiment during use of the AR device.

FIG. 4 is a diagram for describing insertion of a shape model in the space indicated by spatial information.

FIG. 5 is a diagram for describing change occurring in the space and a first example of audio processes.

FIG. 6 is a diagram for describing change occurring in the space and a second example of audio processes.

### DESCRIPTION OF EMBODIMENTS

A three-dimensional audio processing method according to a first aspect of the present disclosure is a three-dimensional audio processing method for use in reproducing three-dimensional audio using an augmented reality (AR) device, and the three-dimensional audio processing method includes: obtaining change information indicating change occurring in a space in which the AR device is located when content that includes a sound is being output in the AR device; selecting, based on the change information, one or more audio processes among a plurality of audio processes for rendering sound information indicating the sound; executing only the one or more audio processes selected among the plurality of audio processes; and rendering the sound information based on a first processing result of each of the one or more audio processes executed.

Accordingly, when change occurs in the space, since only the one or more audio processes selected among the plurality of audio processes are executed, the amount of computation for reflecting the change in the space in the sound information is reduced when compared to a case where all of the plurality of audio processes are executed. Thus, according to the three-dimensional audio processing method, since the amount of computation, when change occurs in the space, is prevented from increasing, changes in acoustic features occurring due to changes in the space are readily reflected in the rendering of the sound information.

Furthermore, for example, a three-dimensional audio processing method according to a second aspect of the present disclosure is the three-dimensional audio processing method according to the first aspect of the present disclosure, wherein in the rendering, the sound information may be rendered based on the first processing result of each of the one or more audio processes and a second processing result obtained in advance, the second processing result being a second processing result of each of an other one or more audio processes among the plurality of audio processes excluding the one or more audio processes.

Accordingly, since the second processing result obtained in advance is used as a processing result of the other one or more audio processes, the amount of computation for reflecting the change in the space in the sound information is reduced when compared to a case where additional computation is performed in some form or other for the other one or more audio processes.

Furthermore, for example, a three-dimensional audio processing method according to a third aspect of the present disclosure is the three-dimensional audio processing method according to the first aspect or the second aspect of the present disclosure, wherein the change information may include information indicating an object that has changed in the space, and in the selecting, the one or more audio processes may be selected based on at least one of an acoustic characteristic of the object or a position of the object.

Accordingly, since the one or more audio processes are selected in accordance with at least one of the acoustic characteristic of the object or the position of the object, sound information that more appropriately includes the degree of influence of the object can be generated. Thus, sound information capable of being used to output a more appropriate sound in accordance with the state of the space at that point in time can be generated.

Furthermore, for example, a three-dimensional audio processing method according to a fourth aspect of the present disclosure is the three-dimensional audio processing method according to the third aspect of the present disclosure, wherein in the selecting: the acoustic characteristic of the object and the position of the object may be used; whether the one or more audio processes that correspond to the object are to be executed may be determined based on the position of the object; and when the one or more audio processes are determined to be executed, the one or more audio processes may be selected based on the acoustic characteristic of the object.

Accordingly, since it is determined whether the one or more audio processes are to be executed, execution of unnecessary audio processes can be prevented.

Furthermore, for example, a three-dimensional audio processing method according to a fifth aspect of the present disclosure is the three-dimensional audio processing method according to any one of the first through fourth aspects of the present disclosure, wherein the change information may include information indicating an object that has changed in the space, and in the executing, the one or more audio processes may be executed using a shape model obtained by simplifying the object.

Accordingly, since a shape model obtained by simplifying the object is used, the amount of computation performed in audio processing can be reduced when compared to a case where the shape of the object itself is used. In particular, by using shape models for objects for which movement is difficult to predict (people or the like, for example), the amount of computation can be effectively reduced. Thus, according to the three-dimensional audio processing method, the change in the acoustic feature caused by the change occurring in the space can be readily reflected in rendering performed on the sound information.

Furthermore, for example, a three-dimensional audio processing method according to a sixth aspect of the present disclosure is the three-dimensional audio processing method according to the fifth aspect of the present disclosure, wherein the shape model may be obtained, based on a type of the object, by reading a shape model that corresponds to the object from storage in which a plurality of shape models are stored in advance.

Accordingly, since the shape model need only be read from storage, the amount of computation for obtaining the shape model can be reduced when compared to a case where the shape model is generated by computation or the like.

Furthermore, for example, a three-dimensional audio processing method according to a seventh aspect of the present disclosure is the three-dimensional audio processing method according to the fifth aspect or the sixth aspect of the present disclosure, wherein the shape model may be inserted in spatial information indicating the space, and in the selecting, the one or more audio processes may be selected based on the spatial information in which the shape model is inserted.

Accordingly, the state in the space at that point in time can be recreated using the shape model. By using such spatial information, one or more audio processes appropriate for the state in the space at that point in time can be selected.

Furthermore a three-dimensional audio processing device according to an eighth aspect of the present disclosure is a three-dimensional audio processing device for use in reproducing three-dimensional audio using an augmented reality (AR) device, and the three-dimensional audio processing device includes: an obtainer that obtains change information indicating change occurring in a space in which the AR device is located when content that includes a sound is being output in the AR device; a selector that selects, based on the change information, one or more audio processes among a plurality of audio processes for rendering sound information indicating the sound; an audio processor that executes only the one or more audio processes selected among the plurality of audio processes; and a renderer that renders the sound information based on a first processing result of each of the one or more audio processes executed. Furthermore, a recording medium according to a ninth aspect of the present disclosure is a non-transitory computer-readable recording medium having recorded thereon a program for causing a computer to execute the three-dimensional audio processing method according to any one of the first through seventh aspects of the present disclosure.

Accordingly, the same advantageous effects as the above-mentioned three-dimensional audio processing method are achieved.

It should be noted that these general and specific aspects may be implemented as a system, a method, an integrated circuit, a computer program, or a computer-readable, non-transitory recording medium, such as a CD-ROM, or may be implemented as any combination of a system, a method, an integrated circuit, a computer program, and a recording medium. The program may be stored in advance in the recording medium or may be supplied to a recording medium via a wide-area communication network, such as the Internet or the like.

Hereinafter, an embodiment will be described in detail with reference to the drawings.

It should be noted that the embodiment described below merely illustrates generic or specific examples of the present disclosure. The numerical values, elements, the arrangement and connection of the elements, steps, the order of the steps, etc., described in the following embodiment are mere examples, and are therefore not intended to limit the present disclosure. Accordingly, among elements in the following embodiment, those not appearing in any of the independent claims will be described as optional elements.

It should be noted that the figures are schematic diagrams and are not necessarily precise illustrations. Therefore, for example, the scaling, and so on, depicted in the drawings is not necessarily uniform. Moreover, elements that are substantially the same are given the same reference signs in the respective figures, and redundant descriptions may be omitted or simplified.

Furthermore, in the present description, numbers and numerical ranges refer not only to their strict meanings, but also include variations that fall within an essentially equivalent range, such as a range of deviation of a few percent (or about 10 percent).

### Embodiment

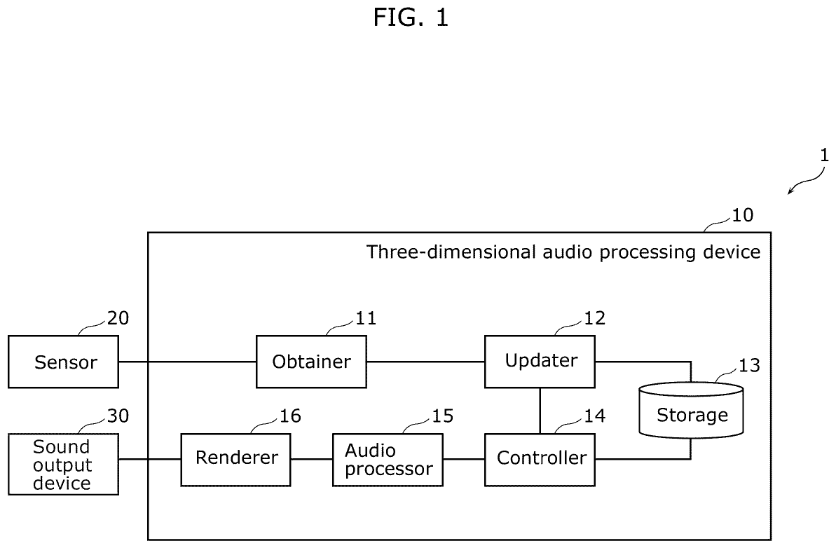

Hereinafter, a three-dimensional processing method according to the present embodiment and a three-dimensional audio processing device for executing the three-dimensional audio processing method will be described with reference to FIG. 1 through FIG. 6.

### [1. Configuration of Three-dimensional Audio Processing Device]

First, a configuration of the three-dimensional audio processing device according to the present embodiment will be described with reference to FIG. 1. FIG. 1 is a block diagram of a functional configuration of three-dimensional audio processing device 10 according to the embodiment.

As illustrated in FIG. 1, three-dimensional audio processing device 10 is included in three-dimensional audio reproduction system 1, and three-dimensional audio reproduction system 1 includes sensor 20 and sound output device 30 in addition to three-dimensional audio processing device 10. Although three-dimensional audio reproduction system 1 is provided in an AR device, for example, at least one of three-dimensional audio processing device 10 or sensor 20 may be implemented in a device external to the AR device.

Three-dimensional audio reproduction system 1 is a system for rendering sound information (sound signal), and for outputting (reproducing) a sound based on the sound information rendered, such that a sound that corresponds to the state of an indoor space (hereinafter also simply referred to as the “space”) in which a user wearing the AR device is present is emitted from sound output device 30 of the AR device.

The indoor space may be any space so long as the space is somewhat enclosed, and examples include a living room, a hall, a conference room, a hallway, a stairwell, a bedroom, and the like.

Although the AR device is a goggle-style AR wearable terminal that can be worn by a user (so-called smart glasses) or a head-mounted display for AR use, the AR device may be a smartphone or a mobile terminal, such as a tablet-style information terminal or the like. It should be noted that augmented reality refers to a technique in which an information processing device is used to further add information to a real-world environment of scenery, topography, objects, or the like of an actual space.

The AR device includes a display, a camera (an example of sensor 20), a loudspeaker (an example of sound output device 30), a microphone, a processor, memory, and the like. Furthermore, the AR device may include a depth sensor, a global positioning sensor (GPS), laser imaging detection and ranging (LIDAR), and the like.

Acoustic features of the space, as spatial information, are necessary when rendering the sound information. Accordingly, as one area of consideration, spatial information on the actual space in which the AR device is used is obtained before use of the AR device, and the spatial information obtained in advance of the point in time at which the AR device is started up (or before startup) is input to a processing device that performs rendering. The spatial information that includes the acoustic features may, for example, be obtained by measuring the space in advance, or may be obtained by computation by a computer. It should be noted that the spatial information includes, for example, the size and shape of the space, acoustic features of construction materials of which the space is composed of, acoustic features of objects in the space, positions and shapes of objects in the space, and the like.

However, during use of the AR device, changes may conceivably occur in the space, such as by a person exiting or entering the space, an object in the space being moved, or an object in the space being added or removed. If such changes occur in the space, the acoustic features (acoustic characteristics) of the space will change. Accordingly, although rendering will once again need to be performed (additional rendering) in order to allow the AR device to output sound that corresponds to the state of the space, there are concerns that the computational load of three-dimensional audio processing device 10, which is a processing device, will increase. In particular, when handling objects for which movement is difficult to predict, such as people or the like, sensing will need to be performed at a high rate of frequency, thereby leading to concerns that the computational load of three-dimensional audio processing device 10 will increase.

In view of this, hereinafter, three-dimensional audio processing device 10 that can reduce the amount of computation performed during additional rendering will be described as a device capable of readily reflecting, in the rendering of a sound, changes to the acoustic features of a space caused by changes occurring in the space in which the AR device is located. It should be noted that “during use of an AR device” refers to a state where a user is using an AR device that is started up, and this specifically refers to a state where content including sound is being output in the AR device worn by the user.

Three-dimensional audio processing device 10 is an information processing device for use in reproducing three-dimensional audio using an AR device, and includes obtainer 11, updater 12, storage 13, controller 14, audio processor 15, and renderer 16.

Obtainer 11 obtains change information indicating change in the space in which the user wearing the AR device is present from sensor 20 during use of the AR device. A “change in a space” refers to a change in the objects disposed in the space that causes the acoustic features of the space to change, and examples include an object in the space being moved (position changing), an object disposed in the space being added or removed, and a change in at least one of the shape or size of an object, such as to cause the object in the space to deform, for example.

The change information includes information indicating objects that have changed in the space. The change information may, for example, include information indicating the type and the position in the space of each object that has changed in the space. The types of objects include types, such as people, pets, robots (autonomous mobile robots, for example), as moving objects (mobile bodies), and desks, partitions, and the like, as stationary objects, but the types are not limited to these examples.

Furthermore, the change information may include images in which objects in the space (objects that have, for example, changed in the space) are visible. In this case, obtainer 11 may include a function for detecting that change has occurred in the space. Obtainer 11 may, for example, include a function for detecting the type of an object and the position of an object in the space from an image by image processing or the like. Obtainer 11 may function as a detector that detects that change has occurred in the space.

Obtainer 11 may, for example, be configured to include a communication module (communication circuit).

Updater 12 executes a process for recreating the current state of the actual space in the space indicated by the spatial information obtained in advance. Updater 12 may be described as executing a process that updates the spatial information obtained in advance in accordance with the current state of the actual space. When an object is added, updater 12 inserts (positions) a shape model (object) corresponding to the type of the object included in the change information (hereinafter also referred to as the “target object”) in the space indicated by the spatial information obtained in advance, at a position in the space indicated by the spatial information that corresponds to the position of the target object. Updater 12, determines the shape model based on the type of the target object and a table in which types of target objects and shape models are associated with each other. Updater 12 obtains, based on the type of the object, the shape model by reading a shape model that corresponds to the object from storage 13 in which a plurality of shape models have been stored in advance. Although “in advance” refers, for example, to a timing prior to when the content that includes sound is output in the AR device, this example is non-limiting.

The shape model is a model that simplifies the object (acts as a mock-up of the object), and is, for example, depicted as a type of three-dimensional shape. The three-dimensional shape is a shape that corresponds to the object, and each type of object is set in advance with a corresponding shape model, for example. Although the three-dimensional shapes include, for example, prisms, cylinders, cones, spheres, plates, or the like, these examples are non-limiting. If the object is a person, for example, a quadrangular prism may be set as the shape model.

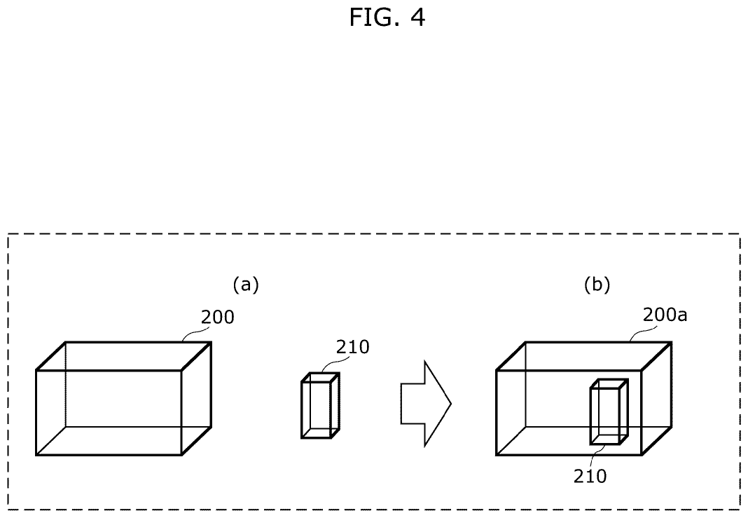

It should be noted that the shape model may be formed as a combination of two or more types of three-dimensional shapes, and moreover, any shape is sufficient as long as the amount of computation performed when executing audio processing can be reduced when compared to that required for executing audio processing on the shape of the actual object. Furthermore, hereinafter, spatial information in which a target object has been inserted (space 200a shown in (b) in FIG. 4, as described later, for example) is also referred to as updated spatial information.

Furthermore, when the number of objects decreases, updater 12 removes the target objects from the spatial information obtained in advance. Furthermore, when an object is moved, updater 12 moves the target object in the spatial information obtained in advance to the position of the target object included in the change information. Furthermore, when an object becomes deformed, updater 12 deforms the target object in the spatial information obtained in advance to the shape of the target object included in the change information.

Storage 13 is a storage device that stores the various tables used by updater 12 and controller 14. Furthermore, storage 13 may store the spatial information obtained in advance. Here, “in advance” refers to a timing prior to when the user uses the AR device in the target space.

Controller 14 selects, based on the change information, one or more audio processes among a plurality of audio processes for rendering the sound information (original sound information) indicating the sound to be output from the AR device. Controller 14 may, for example, select the one or more audio processes based on the type of an object. Controller 14 may, for example, select the one or more audio processes based on at least one of an acoustic feature (acoustic characteristic) of an object or a position of an object. Furthermore, controller 14 may determine to select the one or more audio processes based on the spatial information in which a shape model has been inserted. Furthermore, when there are a plurality of objects, controller 14 may select one or more audio processes for each of the plurality of objects. In this manner, controller 14 functions as a selector that selects the one or more audio processes.

The plurality of audio processes include at least two or more of processes related to sound reflection, processes related to sound reverberation, processes related to sound occlusion (shielding), processes related to sound attenuation by distance, processes related to sound diffraction, and the like, occurring in the space.

“Reflection” refers to a phenomenon where sound incident on an object at a given angle bounces off the object. “Reverberation” refers to a phenomenon where sound generated in a space vibrates and can be heard due to reflection and the like, and the time during which a sound pressure level attenuates by a certain degree (60 dB, for example) after a sound source has stopped emitting sound is defined as the reverberation time. “Occlusion” refers to an effect in which sound attenuates when a given object (obstruction) is present between a sound source and a listening point. “Attenuation by distance” refers to a phenomenon where sound attenuates in accordance with the distance between a sound source and a listening point. “Diffraction” refers to a phenomenon where sound can be heard from a direction different from the actual direction of a sound source due to the sound being reflected in a roundabout manner when an object is present between a sound source and a listening point.

Audio processor 15 executes the one or more audio processes selected by controller 14. Audio processor 15 executes only the one or more audio processes among the plurality of audio processes. Audio processor 15 executes each of the one or more audio processes, based on the updated spatial information and a characteristic of the object, and calculates a processing result of each of the one or more audio processes. The processing results include coefficients used for rendering (filtering coefficients, for example). The processing result of each of the one or more audio processes is an example of a first processing result. It should be noted that the plurality of audio processes have been set in advance.

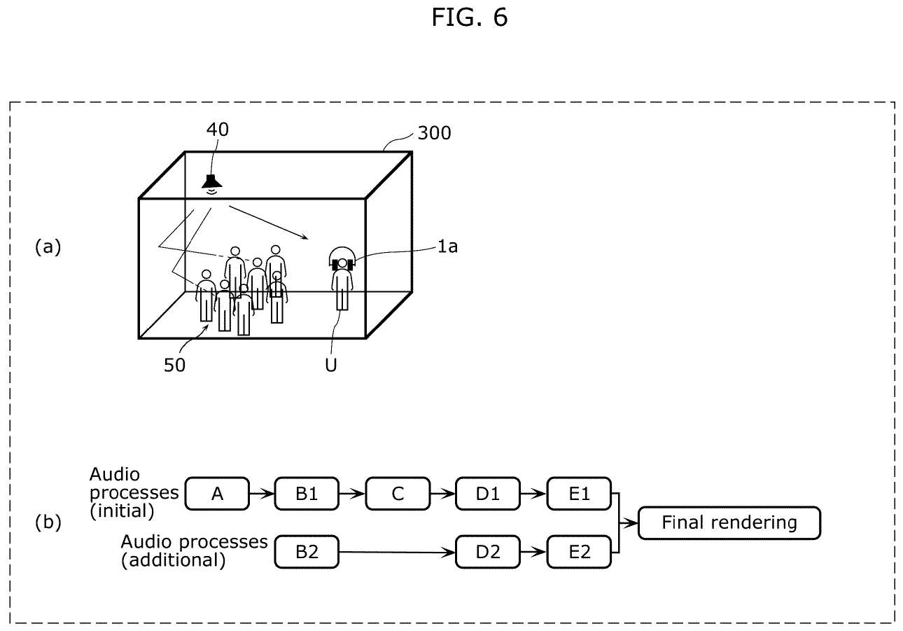

Renderer 16 renders the sound information originally saved (additional rendering) by using the processing result of each of the one or more audio processes. Renderer 16 outputs, as audio control information, a result for which a convolution operation is performed on the sound information by using a coefficient obtained for each of the one or more audio processes. Details of the processes of renderer 16 will be described later with reference to FIG. 6. Note that “rendering” refers to a process in which sound information is adjusted in accordance with an indoor environment of a space such that sound is emitted at a predetermined sound volume level and from a predetermined sound emission position.

Sensor 20 is attached in an orientation so as to make sensing possible in the space, and senses change occurring in the space. Furthermore, sensor 20 is disposed in the space, and is communicably connected to three-dimensional audio processing device 10. Sensor 20 is capable of sensing the shape, the position, and the like of an object in the space. Furthermore, sensor 20 may be capable of identifying the type of an object in the space. Sensor 20 is configured to include an imaging device, such as a camera or the like, for example.

Sensor 20 may determine whether an AR device is located in the space in which sensor 20 is provided, and whether the AR device has been started up by obtaining, from the AR device, position information and information indicating that the AR device is in use.

Sound output device 30 emits sound based on the audio control information obtained from three-dimensional audio processing device 10. Sound output device 30 includes a loudspeaker and a processor, such as a central processing unit (CPU).

### [2. Operation of Three-dimensional Audio Processing Device]

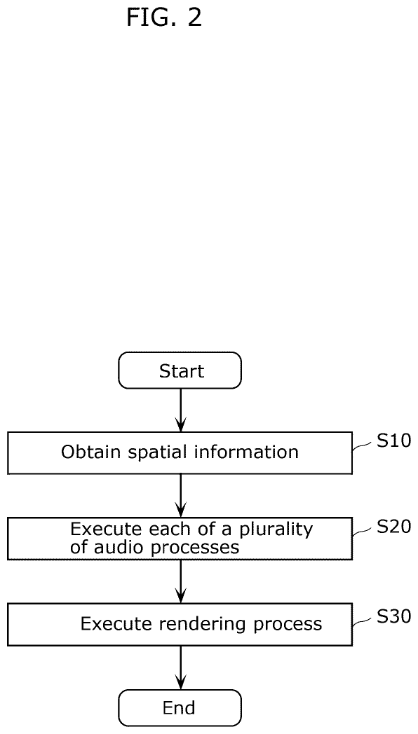

Next, operation of three-dimensional audio processing device 10 as configured above will be described with reference to FIG. 2 through FIG. 6.

First, operation before use of the AR device will be described with reference to FIG. 2. FIG. 2 is a flowchart illustrating operation (three-dimensional audio processing method) of three-dimensional audio processing device 10 according to the embodiment before use of the AR device. It should be noted that the processes illustrated in FIG. 2 may be executed by a device other than three-dimensional audio processing device 10.

As illustrated in FIG. 2, obtainer 11 obtains spatial information that includes an acoustic feature of a space (S10). Obtainer 11 obtains the spatial information from sensor 20, for example.

Next, audio processor 15 executes each of the plurality of audio processes by using the spatial information (S20).

Next, renderer 16 executes a rendering process on the sound information by using a processing result (an example of a second processing result) of each of the plurality of audio processes (S30). As a rendering process, renderer 16 consolidates the processing results (coefficients, for example) of each of the plurality of audio processes, and performs a convolution operation on the sound information using the consolidated processing results. As an audio process, for example, renderer 16 calculates a binaural room impulse response (BRIR) to which characteristics of a human head or characteristics of the space have been reflected, and performs a convolution operation on the sound information using the BRIR calculated. It should be noted that the audio process is not limited to these examples, and the audio process may calculate a head related impulse response (HRIR) or the like, or the audio process may be another audio process. Accordingly, sound information that can reproduce sound corresponding to the spatial information that is obtained in advance is generated.

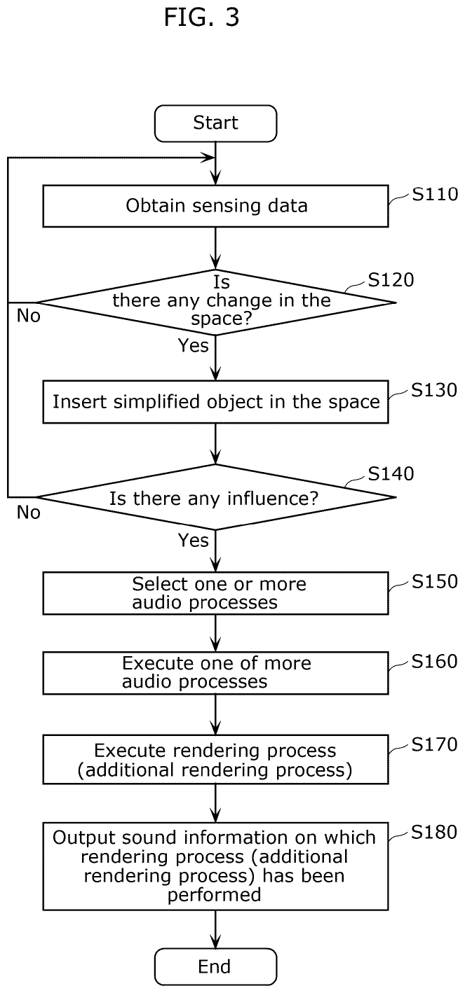

Next, operation during use of the AR device will be described with reference to FIG. 3 through FIG. 6. FIG. 3 is a flowchart illustrating operation (three-dimensional audio processing method) of three-dimensional audio processing device 10 according to the embodiment during use of the AR device. Note that operation in a case in which obtainer 11 functions as a detector will be described with reference to FIG. 3.

Obtainer 11 obtains sensing data sensed by sensor 20 in the space in which the AR device is located during use of the AR device (S110). The sensing data includes information indicating the shape and the size of the space, and sizes and positions of objects in the space, and the like. Obtainer 11 obtains the sensing data periodically or in real time, for example. The sensing data is an example of change information.

Next, obtainer 11 determines whether change has occurred in the space (change in the space) based on the sensing data (S120). Obtainer 11 determines whether change has occurred in the space using the spatial information obtained in step S10 or the sensing data most recently obtained, together with the sensing data obtained in step S110. Obtainer 11 determines the condition to be “Yes” in step S120 in such cases where an object moves in the space, an object is added or removed, an object becomes deformed, or the like. Note that in the example described below, spatial information obtained in step S110 is the target that is to be compared with the sensing data obtained in step S110. Hereinafter, an example will be described of operation in a case where an object is added to an actual space.

Next, when a change in the space is determined to have occurred by obtainer 11 (“Yes” in S120), updater 12 inserts a simplified object (shape model) in the space (spatial information) (S130). Inserting a shape model in a space is one example of how spatial information can be updated.

FIG. 4 is a diagram for describing insertion of shape model 210 in space 200 indicated by spatial information. Here, an example is described in which an object included in the change information is a person.

In (a) in FIG. 4, space 200 indicated by the spatial information obtained in advance and shape model 210, which is a simplified object corresponding to a person, are illustrated.

In (b) in FIG. 4, space 200a indicated by the spatial information after the simplified object (shape model 210) has been inserted in space 200 is illustrated. In (b) in FIG. 4, shape model 210 is inserted in space 200a. Shape model 210 is inserted in a position in space 200a corresponding to the position of the object in the actual space. The position of the object in the actual space is included in the sensing data obtained by sensor 20.

Furthermore, when obtainer 11 determines that no change has occurred in the space (“No” in S120), updater 12 returns to step S110 and continues processing.

Next, controller 14 determines whether there is an influence on an acoustic feature of space 200a indicated by the spatial information in which shape model 210 has been inserted (S140). Controller 14 performs a determination process in step S140 based on at least one of a characteristic of a scene of the space, a characteristic of a sound source, a position of an object, or the like. The determination process is equivalent to determining whether to execute an audio process that corresponds to the object (whether, for example, additional rendering is necessary). Furthermore, when objects of a plurality of types are added, controller 14 may execute the determination process in step S140 for each of the plurality of types of objects.

Characteristics of a scene include acoustic features of the objects (virtual objects) being recreated by the AR device. Characteristics of a sound source are characteristics of sound indicated by sound information, and include, for example, properties of the sound sources, indicating whether a sound is reverberating, such as with that of an engine in an automobile, or whether a sound is muffled, or the like.

Controller 14 may, for example, determine whether there is an influence on an acoustic feature of the space based on information on objects that have been added to the space. Controller 14 may, for example, determine whether there is an influence on an acoustic feature of the space based on the number of objects that have been added to the space, and sizes and shapes of the objects that have been added to the space, or the like. Controller 14 may, for example, determine that there is an influence on an acoustic feature of the space when the number of objects that have been added is greater than or equal to a predetermined number or when the size of an object that has been added is the same as or larger than a predetermined size.

Furthermore, controller 14 may, for example, determine whether there is an influence on an acoustic feature of the space based on a distance between one of a position of an object (real-world object) included in the spatial information obtained in advance or an object (virtual object) recreated by the AR device, and an object that has been added (real-world object). When this distance is less than or equal to a predetermined distance, since an assumption can be made that an acoustic feature of the space will change due to interaction between objects, controller 14 determines that there is an influence on the acoustic feature of the space. This is equivalent to executing an audio process, or in other words, determining to execute additional rendering. Furthermore, when this distance is greater than the predetermined distance, since an assumption can be made that the influence on the acoustic feature of the space due to interaction between objects is small, controller 14 determines that there is no influence on the acoustic feature. This is equivalent to not executing an audio process, or in other words, determining to not execute additional rendering.

It should be noted that distances used to determine whether there is an influence on an acoustic feature of the space are set for each acoustic feature of an object (virtual object) and each characteristic of a sound source, and may be stored in storage 13. Furthermore, in the determination process in step S140, controller 14 may further use characteristics (hardness, softness, or the like) of each object in the space.

It should be noted that controller 14 may execute the determination process in step S140 using a table in which characteristics (hardness, size, and the like, for example) of objects and indications on whether audio processing is to be executed are associated with each other.

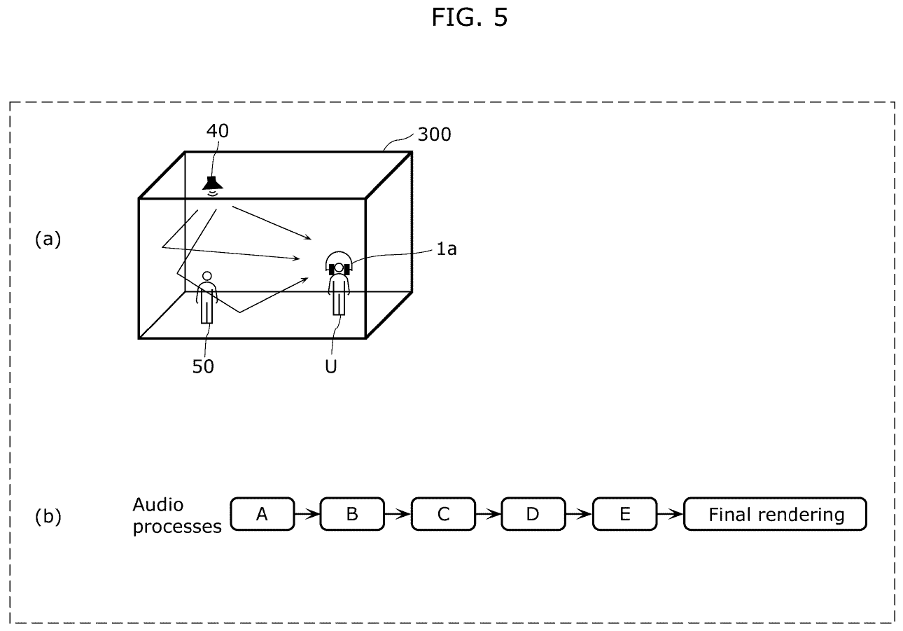

FIG. 5 is a diagram for describing change occurring in a space and a first example of audio processes. (a) in FIG. 5 illustrates a situation in actual space 300 where user U wearing AR device 1a is located in actual space 300, and where one person 50 is added during use of AR device 1a. It should be noted that sound output device 40 is a virtual object recreated by AR device 1a, and is an object that does not actually exist in actual space 300. In this case, three-dimensional audio processing device 10 recreates sound that is output from sound output device 40 and reaches user U.

Since the influence on an acoustic feature of actual space 300 caused by adding one person 50 would conceivably be small, in this case, an additional rendering process is not executed. When, for example, the number of persons 50 added is less than a predetermined number, controller 14 may determine not to execute the additional rendering process. Furthermore, when a person 50 added is farther away than a predetermined distance from user U, for example, controller 14 may determine that there is no influence and may, for example, not execute the additional rendering process.

It should be noted that the “additional rendering process” refers to a process in which an audio process is executed in parallel while the AR device is being used, and rendering is executed using a processing result of the audio process executed.

FIG. 6 is a diagram for describing change occurring in the space and a second example of audio processes. (a) in FIG. 6 illustrates a situation in actual space 300 where user U wearing AR device 1a is located in actual space 300, and where a plurality of persons 50 are added during use of AR device 1a.

Since the influence on an acoustic feature of actual space 300 caused by adding a plurality of persons 50 would conceivably be large, in this case, the additional rendering process is executed. When, for example, the number of persons 50 added is greater than or equal to a predetermined number, controller 14 may determine that there is an influence, and may, for example, execute the additional rendering process on the sound information.

Referring again to FIG. 3, when controller 14 determines that there is an influence (“Yes” in S140), processing proceeds to step S150, and when controller 14 determines that there is no influence (“No” in S140), processing proceeds to step S110 and processing continues to be performed. Accordingly, controller 14 functions as a determiner.

Next, when controller 14 determines that there is an influence (“Yes” in S140), controller 14 selects one or more audio processes based on the change information (S150). Controller 14 may, for example, select the one or more audio processes based on the type of an object. Controller 14 may determine to select the one or more audio processes that need to be executed on an object for which it is determined that there is an influence by using a table in which types of objects and the one or more audio processes are associated with each other. This table is created in accordance with characteristics of objects. For example, when an object is hard, since the object will influence reflection characteristics, which are an acoustic feature, this type of object is associated with one or more audio processes that include a process related to the reflection of sound. Accordingly, controller 14 may select the one or more audio processes based on an acoustic characteristic of an object.

Furthermore, controller 14 may select the one or more audio processes based on a positional relationship between sound output device 40, user U, and an object, or the size of the object. When, for example, the size of an object between sound output device 40 and user U increases to a size larger than or equal to a predetermined size, since occlusion may be influenced, controller 14 may select one or more audio processes that include a process related to the occlusion of sound. When the size of an object between sound output device 40 and user U increases to a size less than a predetermined size, since the influence on acoustic features of the space is small, controller 14 may determine “No” in step S140.

It should be noted that the table may be a table in which acoustic features (acoustic characteristics) of objects and the one or more audio processes are associated with each other.

Next, audio processor 15 executes the one or more audio processes selected by controller 14 (S160). In other words, in step S160, audio processor 15 does not execute any audio processes other than the one or more audio processes selected, among the plurality of audio processes.

The audio processes (initial) illustrated in (b) in FIG. 6 are audio processes that are executed in step S20 shown in FIG. 2, and five different audio processes, namely A, B (B1), C, D (D1), and E (E1) are individually executed. On the other hand, the audio processes (additional) illustrated in (b) in FIG. 6 are audio processes that are executed in step S150 shown in FIG. 3, and only three audio processes that have been selected as the one or more audio processes, namely, B (B2), D (D2), and E (E2) are executed. It should be noted that each of B1 and B2, D1 and D2, and E1 and E2 are audio processes related to the same acoustic feature, and for each of these, different spatial information is used for processing. Each of the processing results of audio processes B (B2), D (D2), and E (E2) are an example of a first processing result, and each of the processing results of audio processes A and C are an example of a second processing result.

Accordingly, in step S150, only a portion of audio processes are executed among the audio processes executed in step S20. In other words, in step S150, the entirety of the plurality of audio processes executed in step S20 is not executed. Accordingly, when compared to a case where all five of the audio processes are executed, the amount of computation performed by three-dimensional audio processing device 10 can be reduced.

Next, renderer 16 executes a rendering process (additional rendering) on the sound information by using each of the processing results of the one or more audio processes (S170). Renderer 16 executes rendering (final rendering as illustrated in (b) in FIG. 6) using each of the processing results of the audio processes (initial) and the audio processes (additional) illustrated in (b) in FIG. 6. Renderer 16 executes rendering using each of the processing results of five audio processes, namely, A, B (B2), C, D (D2), and E (E2). Renderer 16 gives priority to using the processing result of audio process B (B2) over the processing result of audio process B (B1). The same applies to audio processes D (D2) and E (E2). Renderer 16 can also be said to give priority to using a processing result of a given audio process obtained using the most recent spatial information over a processing result of the given audio process from the past.

Accordingly, in the rendering of the sound information (additional rendering) executed during use of the AR device, three-dimensional audio processing device 10 renders the sound information based on each of the processing results of the one or more audio processes (an example of first processing results) and second processing results obtained in advance, which are each of the processing results of an other one or more audio processes among the plurality of audio processes excluding the one or more audio processes. Furthermore, it can also be said that three-dimensional audio processing device 10 prevents each of the other one or more audio processes from being recalculated, and only permits the audio processes necessary corresponding to the object that has been added to be recalculated.

Referring again to FIG. 3, renderer 16 outputs the sound information (audio control information) on which the rendering process (additional rendering) has been performed to sound output device 30 (S180). Accordingly, sound output device 30 can output a sound that corresponds to the state in the space at that point in time.

It should be noted that the processes of steps S110 to S180 are executed during use of the AR device.

It should be noted that the audio processes illustrated in (b) in FIG. 5 correspond to the audio processes (initial) illustrated in (b) in FIG. 6.

### OTHER EMBODIMENTS

Although a three-dimensional audio processing method, and the like, according to one or more aspects is described above based on the foregoing embodiment, the present disclosure is not limited to this embodiment. Forms obtained by various modifications to the embodiments that may be conceived by a person of ordinary skill in the art or forms obtained by combining elements in different embodiments, for as long as they do not depart from the essence of the present disclosure, may also be included in the present disclosure.

Although an example of a three-dimensional audio processing device that includes both an updater and a controller was described in the above embodiment, it is sufficient so long as the three-dimensional audio processing device includes at least one of an updater or a controller. For example, of an updater and a controller, it is sufficient if the three-dimensional audio processing device only includes an updater. Such a three-dimensional audio processing device iS a three-dimensional audio processing device for use in reproducing three-dimensional audio using an AR device, and the three-dimensional audio processing device includes: an updater (inserter) that obtains change information indicating change occurring in a space in which the AR device is located when content that includes a sound is output to the AR device, and inserts a shape model that indicates an object, which is an object included in the change information, that has been changed, in a simplified manner in the space indicated by spatial information of the space obtained in advance; an audio processor that executes, by using the shape model that simplifies the object, audio processing for a plurality of audio processes for rendering sound information indicating the sound; and a renderer that renders the sound information based on a processing result of each of the plurality of audio processes executed. Furthermore, the present disclosure may be implemented as a three-dimensional audio processing method executed by the three-dimensional audio processing device, or as a program for causing a computer to execute the three-dimensional audio processing method.

Furthermore, in the above embodiment, although an example was described in which changes in the object during use of the AR device are changes in a real-world object, this example is non-limiting, and changes in the object may be changes in a virtual object. In other words, changes in an object during use of the AR device may include a virtual object moving, a virtual object being added or removed, a virtual object being deformed, or the like. In this case, the obtainer of the three-dimensional audio processing device obtains change information from a display control device that controls display of the AR device.

Furthermore, in the above embodiment, although an example was described in which a three-dimensional audio processing device is equipped in an AR device, the three-dimensional audio processing device may be equipped in a server. In this case, the AR device and the server are communicably connected (capable of wireless communication, for example). Furthermore, the three-dimensional audio processing device may be equipped in or connected to any device that is used indoors and that outputs sound. This device may be a stationary audio device or may be a video game console (portable video game console, for example).

Furthermore, in the above embodiment, although an example was described in which the updater directly inserts the shape model into the space, this example is non-limiting, and the shape model may, for example, be inserted in the space after changes have been made to the size (height, for example) of the shape model in accordance with sensing data. Furthermore, the updater may, based on the shape of an object included in the sensing data, combine a plurality of shape models to generate a new shape model that corresponds to the shape of the object, and may insert the new shape model generated into the space.

Furthermore, changes in the space according to the above embodiment may, for example, include changes to the space itself. “Changes to the space itself” refer to changes to at least one of the size or the shape of the space itself due to the opening or closing of a door, sliding door, or the like disposed between two spaces, for example.

Furthermore, in the above embodiment, although a case where a shape model is used was described, this example is non-limiting, and for a portion of objects, the shapes of the objects themselves may be used to execute the processes in steps S140 and onward. The controller may determine, between step S120 and step S130, for example, whether to substitute the shapes of the objects with shape models based on the types of the objects or the shapes of the objects included in the change information. Moreover, the controller may execute step S130 exclusively in cases where it is determined that a shape is to be substituted, and may insert the shape of the object itself into the space in cases where it is determined that the shape is not to be substituted. When it is assumed, based on types of objects or shapes of objects, that the amount of computation performed in the audio processes is less than or equal to a predetermined amount, the controller may, for example, determine that the shapes are not to be substituted. The controller may make this determination based on a table in which types of object or shapes of objects and indications on whether they are to be substituted are associated with each other. Furthermore, the table is set in advance and is stored in storage.

Furthermore, in the above embodiment, each element may be configured as dedicated hardware, or may be implemented by executing a software program suitable for each element. Alternatively, the elements may be implemented by a program executor, such as a CPU or a processor, reading and executing a software program recorded in a recording medium, such as a hard disk or semiconductor memory.

Furthermore, the sequence in which respective steps in the flowcharts are executed is given as an example to describe the present disclosure in specific terms, and thus other sequences are possible. Furthermore, a portion of the above-mentioned steps may be executed simultaneously (in parallel) with other steps, and a portion of the above-mentioned steps need not be executed.

Furthermore, while the block diagram illustrates one example of the division of functional blocks, a plurality of functional blocks may be realized as a single functional block, a single functional block may be broken up into a plurality of functional blocks, and part of one function may be transferred to another functional block. Furthermore, the functions of a plurality of functional blocks having similar functions may be processed by a single piece of hardware or software in parallel or by time-division.

Furthermore, the three-dimensional audio processing device according to the above embodiment may be implemented as a single device, and may be implemented by a plurality of devices. For example, of the elements included in the three-dimensional audio processing device, at least a portion may be implemented by a device, such as a server, that can communicate with the AR device. When the three-dimensional audio processing device is implemented by a plurality of devices, the elements included in the three-dimensional audio processing device may be distributed among the plurality of devices in any manner. When the three-dimensional audio processing device is implemented by a plurality of devices, the communication method of the plurality of devices is not particularly limited, and may be wireless communication and may be wired communication. Furthermore, a combination of wireless communication and wired communication may be used between the devices.

Furthermore, the respective elements described in the above embodiment may be implemented as software, or typically may be implemented as a large-scale integration (LSI) circuit, which is an integrated circuit. These elements may be configured as individual chips or may be configured so that a part or all of the elements are included in a single chip. Here, the circuit integration is exemplified as an LSI, but depending on the degree of integration, the integration may be referred to as an IC, system LSI, super LSI, or ultra LSI. Furthermore, the method of circuit integration is not limited to LSIs, and implementation through a dedicated circuit (general-purpose circuit that executes a dedicated program) or a general-purpose processor is also possible. A field programmable gate array (FPGA) that allows for programming after the manufacture of an LSI, or a reconfigurable processor that allows for reconfiguration of the connection and the setting of circuit cells inside an LSI may be employed. Furthermore, if an integrated circuit technology that replaces LSI emerges as semiconductor technology advances or when a derivative technology is established, it goes without saying that the elements may be integrated by using such technology.

A system LSI is a super multifunctional LSI manufactured by integrating a plurality of processing units onto a single chip. To be more specific, the system LSI is a computer system configured with a microprocessor, read-only memory (ROM), random-access memory (RAM), or the like. The ROM stores a computer program. The microprocessor operates according to the computer program so that a function of the system LSI is achieved.

Furthermore, one aspect of the present disclosure may be a computer program for causing a computer to execute those characteristic steps included in the three-dimensional audio processing method illustrated in any of FIG. 2 and FIG. 3.

Furthermore, the program may, for example, be a for causing computer to execute the program a three-dimensional audio processing method. Furthermore, one aspect of the present disclosure may be a computer-readable, non-transitory recording medium on which such a program is recorded. For example, such a program may be recorded to the recording medium and may be distributed or placed into circulation. For example, by installing the distributed program onto a device including another processor, and by causing the processor to execute the program, the above respective processes can be performed by the device.

It should be noted that the sound information (sound signal) rendered in the present disclosure may be obtained from a storage device (not illustrated in the drawings) external to three-dimensional audio processing device 10 or storage 13 as an encoded bitstream that includes the sound information (sound signal) and metadata. The sound information may, for example, be obtained by three-dimensional audio processing device 10 as a bitstream encoded in a specified format, such as MPEG-H 3D Audio (ISO/IEC 23008-3). In this case, three-dimensional audio processing device 10 may include an identifier (not illustrated in the drawings), and the identifier may perform a decoding process on the encoded bitstream based on the above-mentioned MPEG-H 3D Audio format or the like. The identifier functions as a decoder, for example. The identifier decodes the encoded bitstream and provides the decoded sound signal and metadata to controller 14. Furthermore, the identifier may be provided outside of three-dimensional audio processing device 10, and controller 14 may obtain the decoded sound signal and metadata.

As an example, the decoded sound signal includes information on a target sound to be reproduced by three-dimensional audio processing device 10. The “target sound” described here refers to a sound emitted by a sound source object (virtual object) present in the sound reproduction space or a natural, ambient sound, and may, for example, include such sounds as machine noises or voices of living things including people. Note that when there are a plurality of sound source objects in the sound reproduction space, three-dimensional audio processing device 10 may obtain a plurality of sound signals that each correspond to each of the plurality of sound source objects.

“Metadata” refers, for example, to information used for controlling audio processes performed on sound information in three-dimensional audio processing device 10. Metadata may be information used for describing a characteristic of a scene being depicted in a virtual space (sound reproduction space). Here, “scene” is a term that collectively refers to all of the elements that represent a three-dimensional video and/or audio event that is modeled by three-dimensional audio processing device 10 by using the metadata. In other words, “metadata” as described here may include not only information for controlling audio processing of acoustic features and the like, but may include information for controlling video processing as well. Needless to say, metadata need only include information for controlling at least one of audio processing or video processing, and may include information used for controlling both.

Three-dimensional audio processing device 10 generates a virtual sound effect by performing an audio process on the sound information by using the metadata included in the bitstream and interactive position information or the like of user U additionally obtained from sensor 20. Processes may conceivably include, for example, the generation of reflected sound, processes related to occlusion, processes related to diffracted sounds, distance attenuation effects, localization, auditory localization processes, or the addition of sound effects, such as doppler effects and the like. Furthermore, information for switching all or part of the sound effects on or off may be added as metadata. Furthermore, controller 14 may select the one or more audio processes for an object based on spatial information in which a shape model has been inserted or the metadata.

It should be noted that all of the metadata or a portion of the metadata may be obtained from a source other than the bitstream of the sound information. For example, either of the metadata for controlling audio or the metadata for controlling video may be obtained from a source other than the bitstream, or both forms of metadata may be obtained from sources other than the bitstream.

Furthermore, when the metadata for controlling video is included in the bitstream obtained by three-dimensional audio processing device 10, three-dimensional audio processing device 10 may also include a function in which three-dimensional audio processing device 10 outputs metadata that can be used for controlling video to a display device that displays an image or a three-dimensional video reproduction device that reproduces three-dimensional video.

Furthermore, as an example, the metadata that is encoded includes information on the sound reproduction space that includes sound source objects that emit sound and obstructing objects, and information on a positioning location used when positioning a sound image of the sound at a predetermined position in the sound reproduction space (i.e., causing the sound to be sensed as arriving from a predetermined direction). Here, an “obstructing object” is an object that may influence sound as sensed by user U by blocking sound or reflecting sound, for example, for sound emitted by a sound source object, from the point at which the sound is emitted until the sound reaches user U. In addition to static objects, obstructing objects may include moving objects, such as people, animals, machines, and the like. Furthermore, when a plurality of sound source objects are present in a sound reproduction space, other sound source objects may act as an obstructing object for a given sound source object. Furthermore, both objects that do not emit sound, such as construction materials, inanimate objects, and the like, and sound source objects that emit sound may act as obstructing objects. Furthermore, “sound source objects” and “obstructing objects” as referred to here may include virtual objects, and may include real-world objects included in spatial information on an actual space obtained in advance.

As spatial information included in metadata, not only is information on shapes in the sound reproduction space included, but information representing the shape and the position of each obstructing object present in the sound reproduction space and the shape and the position of each sound source object present in the sound reproduction space may also be included. The sound reproduction space may be a closed space or open space, and metadata includes information representing the reflectance of structural objects that may reflect sound in the sound reproduction space, such as floors, walls, ceilings, and the like, and the reflectance of obstructing objects present in the sound reproduction space, for example. Here, “reflectance” refers to a ratio between the energy of the reflected sound and the energy of the incident sound, and a reflectance is set for each frequency range of sound. Needless to say, reflectance may be set uniformly regardless of the frequency range of the sound. Furthermore, when the sound reproduction space is an open space, parameters, such as a uniformly set attenuation rate, diffraction sound, initial reflection sound, and the like, may be used.

Although reflectance was described above as a parameter related to obstructing objects and sound source objects included in metadata, metadata may include information other than reflectance. For example, information on the materials of objects may be included as metadata related to both sound source objects and objects that do not emit sound. Specifically, metadata may include parameters, such as diffusivity, transmittance, sound absorptivity, and the like.

Sound volume levels, emission characteristics (directivity), sound reproduction conditions, the number of types of sound sources emitted by one object, information that specifies a sound source region of an object, and the like, may be included as information on sound source objects. Reproduction conditions may be used to define whether a sound is a sound that is continuously playing, or a sound that is activated due to an event. A sound source region of an object may be determined by the relative relationship between the position of user U and the position of the object, or may be determined by using the object as the reference. When a sound source region of an object is determined by the relative relationship between the position of user U and the position of an object, the surface of the object viewed by user U is used as the reference, and user U may, for example, be caused to sense that sound X is being emitted from the right side of the object from the perspective of user U, and that sound Y is being emitted from the left side. When a sound source region of an object is determined by using the object as the reference, which region of the object emits which sound may be determined in a fixed manner, regardless of which direction user U is viewing the object from. For example, user U may be caused to sense that a high-pitched sound is being emitted from the right side of the object, and that a low-pitched sound is being emitted from the left side, when the object is being viewed from the front. In this case, when user U circles around to face the object from the back, user U can be caused to sense that the low-pitched sound is being emitted from the right side, and that the high-pitched sound is being emitted from the left side.

Time until an initial reflection sound is emitted, reverberation time, the ratio of the number of direct sounds to the number of diffuse sounds, and the like, may be included as metadata related to a space. When the ratio of the number of diffuse sounds to the number of direct sounds is zero, user U can be caused to sense only direct sounds.

Information that indicates the position and the orientation of user U is obtained from information other than that included in bitstreams. For example, position information obtained by performing self-position estimation by using sensing information and the like obtained from sensor 20 may be used as information that indicates the position and the orientation of user U. It should be noted that sound information and metadata may be stored in a single bitstream, and may be stored separately in a plurality of bitstreams. In the same manner, sound information and metadata may be stored in a single file, and may be stored separately in a plurality of files.

When sound information and metadata is stored separately in a plurality of bitstreams, information indicating other related bitstreams may be included in a single bitstream or a portion among the plurality of bitstreams in which the sound information and the metadata is stored. Furthermore, information indicating other related bitstreams may be included in the metadata or control information of each bitstream of the plurality of bitstreams in which the sound information and the metadata is stored. When sound information and metadata is stored separately in a plurality of files, information indicating other related bitstreams or files may be included in a single file or a portion among the plurality of files in which the sound information and the metadata is stored. Furthermore, information indicating other related bitstreams or files may be included in the metadata or control information of each bitstream of the plurality of bitstreams in which the sound information and the metadata is stored.

Here, each of the related bitstreams and files are bitstreams and files that may, for example, simultaneously be used when performing an audio process. Furthermore, the information indicating other related bitstreams may be grouped together and described in the metadata or control information of a single bitstream among the plurality of bitstreams that store sound information and metadata, or may be divided up and described in the metadata or control information of two or more bitstreams among the plurality of bitstreams that store sound information and metadata. In the same manner, the information indicating other related bitstreams or files may be grouped together and described in the metadata or control information of a single file among the plurality of files that store sound information and metadata, or may be divided up and described in the metadata or control information of two or more files among the plurality of files that store sound information and metadata. Furthermore, information indicating other related bitstreams or files may be grouped together and described in a control file that is generated separately from the plurality of files that store sound information and metadata. In this case, the control file need not store sound information and metadata.

Here, “information indicating other related bitstreams or files” refers, for example, to identifiers that indicate the other bitstreams, filenames that indicate other files, uniform resource locators (URL), uniform resource identifiers (URI), and the like. In this case, obtainer 11 identifies or obtains a bitstream or file based on information indicating other related bitstreams or files. Furthermore, information indicating other related bitstreams may be included in the metadata or control information of at least a portion of the plurality of bitstreams that store sound information and metadata, or information indicating other related files may be included in the metadata or control information of at least a portion of the plurality of files that store sound information and metadata. Here, a file that includes information that indicates other related bitstreams or files may be a control file, such as a manifesto file or the like used to distribute content, for example.

The identifier (not illustrated in the drawings) decodes the metadata encoded, and provides controller 14 with the metadata decoded. Controller 14 provides audio processor 15 and renderer 16 with the metadata obtained. Here, instead of providing the same metadata to each of a plurality of processors, such as audio processor 15 and renderer 16, controller 14 may provide each processor with the metadata needed by the corresponding processor.

Furthermore, obtainer 11 obtains detection information that includes the amount of rotation, amount of displacement, and the like detected by sensor 20, and the position and the orientation of user U. Obtainer 11 determines the position and the orientation of user U in the sound reproduction space based on the detection information obtained. More specifically, obtainer 11 determines that the position and the orientation of user U indicated by the detection information obtained is the position and the orientation of user U in the sound reproduction space. Furthermore, updater 12 updates the position information included in the metadata in accordance with the position and the orientation of user U that is determined. Consequently, the metadata provided by controller 14 to audio processor 15 and renderer 16 is metadata that includes position information that is updated.

In the present embodiment, although three-dimensional audio processing device 10 has a function as a renderer that generates a sound signal to which sound effects are added, all or part of the function as a renderer may be carried out by a server.

In other words, all or some of the identifier (not illustrated in the drawings), obtainer 11, updater 12, storage 13, controller 14, audio processor 15, and renderer 16 may reside in a server that is not illustrated in the drawings. In this case, a sound signal generated in the server or a synthesized sound signal is received by three-dimensional audio processing device 10 via a communication module that is not illustrated in the drawings, and is reproduced by sound output device 30.

### Industrial Applicability

The present disclosure is applicable to a device and the like that processes sound information indicating sound that is output by an AR device.

1. A three-dimensional audio processing method for use in reproducing three-dimensional audio using an augmented reality (AR) device, the three-dimensional audio processing method comprising:
obtaining change information indicating change occurring in a space in which the AR device is located when content that includes a sound is being output in the AR device;
selecting, based on the change information, one or more audio processes among a plurality of audio processes for rendering sound information indicating the sound;
executing only the one or more audio processes selected among the plurality of audio processes; and
rendering the sound information based on a first processing result of each of the one or more audio processes executed.

2. The three-dimensional audio processing method according to claim 1, wherein
in the rendering, the sound information is rendered based on the first processing result of each of the one or more audio processes and a second processing result obtained in advance, the second processing result being a second processing result of each of an other one or more audio processes among the plurality of audio processes excluding the one or more audio processes.

3. The three-dimensional audio processing method according to claim 1, wherein
the change information includes information indicating an object that has changed in the space, and
in the selecting, the one or more audio processes are selected based on at least one of an acoustic characteristic of the object or a position of the object.

4. The three-dimensional audio processing method according to claim 3, wherein
in the selecting:
the acoustic characteristic of the object and the position of the object are used;
whether the one or more audio processes that correspond to the object are to be executed is determined based on the position of the object; and
when the one or more audio processes are determined to be executed, the one or more audio processes are selected based on the acoustic characteristic of the object.

5. The three-dimensional audio processing method according to claim 1, wherein
the change information includes information indicating an object that has changed in the space, and
in the executing, the one or more audio processes are executed using a shape model obtained by simplifying the object.

6. The three-dimensional audio processing method according to claim 5, wherein
the shape model is obtained, based on a type of the object, by reading a shape model that corresponds to the object from storage in which a plurality of shape models are stored in advance.

7. The three-dimensional audio processing method according to claim 5, wherein
the shape model is inserted in spatial information indicating the space, and
in the selecting, the one or more audio processes are selected based on the spatial information in which the shape model is inserted.

8. A three-dimensional audio processing device for use in reproducing three-dimensional audio using an augmented reality (AR) device, the three-dimensional audio processing device comprising:
an obtainer that obtains change information indicating change occurring in a space in which the AR device is located when content that includes a sound is being output in the AR device;
a selector that selects, based on the change information, one or more audio processes among a plurality of audio processes for rendering sound information indicating the sound;
an audio processor that executes only the one or more audio processes selected among the plurality of audio processes; and
a renderer that renders the sound information based on a first processing result of each of the one or more audio processes executed.

9. A non-transitory computer-readable recording medium having recorded thereon a program for causing a computer to execute the three-dimensional audio processing method according to claim 1.
